(19) United States
(12) Patent Application Publication
(10) Pub. No.: US 2005/0027549 A1
(43) Pub. Date: Feb. 3, 2005

(54) Multi-layer architecture for property management

(75) Inventors: Letian Chen, St. Louis, MO (US); John Quagliata, St. Peters, MO (US); Jason R. Hull, Florissant, MO (US); Sean M. Le, St. Louis, MO (US); David M. Bogue, St. Louis, MO (US)

Correspondence Address: TOLER & LARSON & ABEL L.L.P., 5000 PLAZA ON THE LAKE STE 265, AUSTIN, TX, 78746, US

(73) Assignee: SBC Knowledge Ventures, L.P.

(21) Appl. No.: 10/632,509

(22) Filed: Aug. 1, 2003

(51) Int. Cl. G06F 17/60

(52) U.S. Cl. 705/1

(57) ABSTRACT

A property manager layer retrieves from a persistence layer values of properties used by a software application and provides the values to the application at run time. A user interface layer accepts user input to update at least one of the properties. The persistence layer is responsive to the user interface layer to update the properties based on the user input. The user interface layer notifies the property manager layer that the at least one of the properties has been updated. The property manager layer notifies a property listener for the software application if any updated property value is used by the software application. The property listener modifies at least one program variable in the software application that is dependent on an updated property value without restarting the software application.

### BACKGROUND

1. Field of the Disclosure

The present disclosure relates to methods and systems for managing properties.

2. Description of the Related Art

Many Web applications use properties to allow application data to be accessible and easily updated. As used in this patent application, a property includes a name-value pair that resides externally to application code. Properties are used to initialize variables whose values are subject to change, and therefore should not be hard coded into a computer program.

Properties are well-suited to store values that may change over time such as Uniform Resource Locators (URLs) and error messages. For example, a URL may change because a service moves to a new machine, or an error message may change in response to a client request. Properties are also well-suited for values that may differ for each instance of an application. For example, a test application instance may use different URLs than a production application instance.

There are two standard strategies for using properties in Web applications. A first strategy is to use property files, examples of which include Java properties files and .INI files. A second strategy is to store properties in a database. Both of these strategies are subject to some limitations.

As property files and tables are usually hard to read and not user friendly, manually editing properties is tedious and prone to error. Also, manually editing a file or table does not impose data validation on the property information. Further, manually editing properties can corrupt the file or database.

Directly editing property files and tables may involve accessibility and/or authorization issues. For example, editing properties that are deployed on a remote server may be difficult because of file permissions or database security. Furthermore, editing database tables requires someone with database experience and generally is difficult to perform by non-technical personnel.

In a conventional property system, properties are loaded only once, which means that properties cannot be updated while the application is running. For a property value to be changed, the property file or database must be updated and the application must be restarted. Thus, such properties are not inherently dynamic once an application is running.

To create dynamic properties, polling can be used to detect property changes. However, polling can waste system resources. For example, a significant amount of processing time may be spent needlessly reloading properties or scanning for properties that have changed. Polling imposes a trade-off between resources spent on constantly checking for updates and the timeliness of obtaining the update.

### BRIEF DESCRIPTION OF THE DRAWINGS

The present invention is pointed out with particularity in the appended claims. However, other features are described in the following detailed description in conjunction with the accompanying drawing in which:

FIG. 1 is a block diagram of an embodiment of a multi-layer property manager system; and

FIG. 2 is a screen shot of an embodiment of the property management Web interface.

The use of the same reference symbols in different drawings indicates similar or identical items.

### DESCRIPTION OF THE PREFERRED EMBODIMENT(S)

Embodiments of the present invention provide an efficient and effective system and method for property management in applications such as Web applications. The system provides maintainable, dynamic properties to Web applications while mitigating the shortfalls of conventional property files and databases.

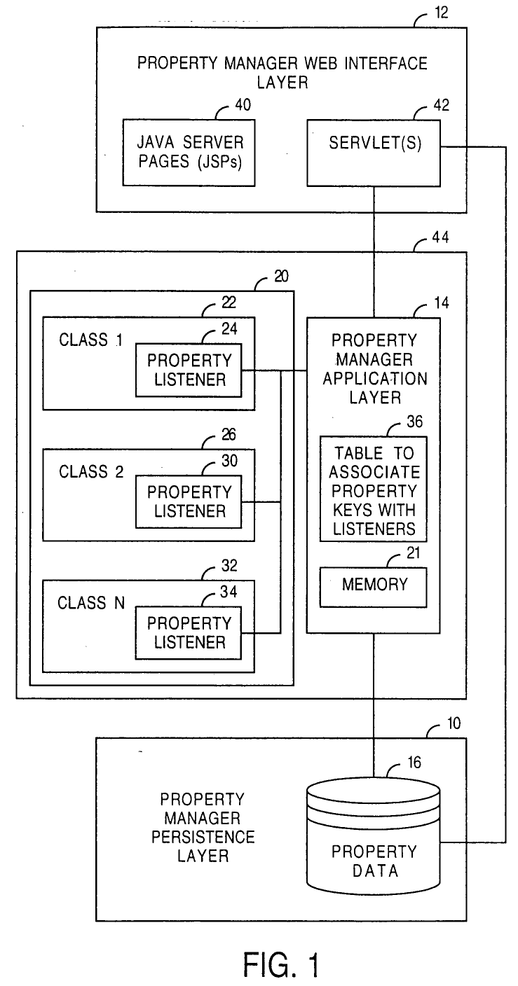

FIG. 1 is a block diagram of an embodiment of a multi-layer property manager system. The system comprises three layers: a persistence layer 10, a Web interface layer 12, and a property manager application layer 14. The persistence layer 10 provides a storage medium 16 to store properties in either a property file or a database table. The persistence layer 10 can store additional information for each property. Examples of the additional information include, but are not limited to, date and/or time stamps indicating when the property was created and/or modified, author names indicating personnel who created and/or modified the property, descriptions or other comments associated with the properties, and version numbers associated with the property.

The Web interface layer 12 provides a Web-based Graphical User Interface (GUI) for users to work with the properties stored by the persistence layer 10. The Web interface layer 12 displays the names and values of properties in an easy-to-read, organized and searchable format. The Web interface layer 12 accepts user input to add, modify, delete and otherwise update the properties and their associated information stored by the persistence layer 10. The user input can be received via the Web, or in general, any computer network such as the Internet, an intranet, an extranet, a local area network or a wide area network. The Web interface layer 12 may be password protected to allow only specific users to log on and view/update parameters.

The persistence layer 10 is responsive to the Web interface layer 12 to update or otherwise modify the properties and their associated information based on the user input. Further, the Web interface layer 12 notifies the property manager layer 14 that the properties have been changed.

The Web interface layer 12 enables properties to be viewed and modified without cumbersome file permissions or database access restrictions. Users need not be concerned about having database expertise or knowledge of a particular property file format.

The Web interface layer 12 can organize properties into categories. With this feature, users can view properties by category, and can add new properties to a category. This feature may be especially useful in applications with a large number of properties. 110191 The property manager application layer 14 offers services to one or more applications 20 that use the properties. The services are exposed to an application through an application programming interface (API) provided by the application layer 14. The services include retrieving properties from the persistence layer 10, subscribing to or otherwise receiving property updates from the Web interface layer 12, and notifying an application when a property update occurs.

When the property manager is initialized, some or all of the properties may be loaded into a memory 21 of the property manager application layer 14. In this way, the property manager application layer 14 does not always have to access the persistence layer 10 to retrieve properties. When the number of properties being managed is small, it is faster for all of the properties to be loaded into the memory 21 at initialization, and subsequently retrieved directly from the memory 21 when requested. When the number of properties being managed is significantly large, it may be beneficial to store only a subset of the properties into the memory 21 for subsequent retrieval.

The motivation for storing properties in the memory 21 is that it is much faster to retrieve information directly from the memory 21 than from the persistence layer 10. However, because the memory 21 has limited capacity, a large number of properties may not be capable of being stored in the memory 21 or may adversely affect system performance if stored in the memory 21. Therefore, storing only a subset of the properties in the memory 21 provides fast access to the subset (which may comprise the most frequently used properties, for example) without degrading system performance.

At run time, an application queries the property manager application layer 14 for a specific property value. In one embodiment of the query, the application passes a property key associated with the property to the property manager application layer 14. When queried, the property manager application layer 14 determines if the key exists. If the key is found, a value corresponding thereto is retrieved from either the persistence layer 10 or the memory 21 and returned to the application. If the key is not found, an error message indicating that the key does not exist is sent back to the application.

Applications register with the property manager application layer 14 to be notified of property updates. In one embodiment, the application creates a property listener for this purpose. For example, a first application class 22 may have a first property listener 24, a second application class 26 may have a second property listener 30, and a third application class 32 may have a third property listener 34. In general, any number N of application classes may have an associated property listener.

Each property listener has a list of property keys of interest to its application. Each property listener is passed to the property manager application layer 14, which in turn registers the listeners. Once a listener has been registered, the property manager application layer 14 notifies the listener when one of the listener's properties has been modified using the Web interface layer 12.

In one embodiment, the property manager application layer 14 maintains a lookup table 36 that records, for each property key, a list of listeners that have registered to listen for that key. When a property is updated, the Web interface layer 12 communicates the property key to the property manager application layer 14. In response thereto, the property manager application layer 14 uses the lookup table 36 to notify all of the listeners that have registered for the property key of the update. In response to receiving notification of the update, the listener modifies the values of the program variables within the application that are dependent on the property.

The above services enable properties to be updated dynamically, i.e. the applications 20 need not be restarted to use updated property values. Further, the above services enable property updates to be made available to any of the applications 20 substantially immediately after a property is modified. The update is communicated to an application in an efficient manner that avoids costly techniques such as polling.

The Web interface layer 12 and the property manager application layer 14 hide the details of the persistence layer 10 from one or more applications 20 which use the property manager system. Beneficially, the applications 20 which use the property manager system need not know a file layout or table structure of the persistence layer 10.

The applications 20 do not directly access the persistence layer 10. The applications 20 access the properties from the persistence layer 10 via the property manager application layer 14 at run time.

Embodiments of the present invention can be used in a variety of software applications. In one particular embodiment, the property manager is used with a middleware application that provides flow through ordering applications to at least one back-end application such as back-end legacy systems. A sample middleware application is a J2EE application that runs on the WebSphere® product from International Business Machines (IBM). The property manager provides a better way to handle properties than simply using JAVA property files.

Further in the particular embodiment, the Web interface layer 12 may be implemented using JAVA Server Pages (JSPs) 40 and one or more servlets 42. For each property displayed by the interface, a description and time stamp are also displayed.

The property manager application layer 14 may be contained within a common project 44 within the middleware application (as depicted in FIG. 1). Alternatively, the property manager application layer 14 may be separate from the project, e.g. the property manager code may be contained in a client JAVA Archive (JAR) file, a Dynamic Link Library (DLL) file, a Microsoft Corporation's Cabinet (CAB) file, or another suitable file type for packaging.

Classes of the middleware application that are to receive property updates create a property listener object and register the listener with the property manager application layer 14.

The persistence layer 10 is implemented using a database such as one available from Oracle Corporation. A row in a property table stores a property key, property value, description and time stamp.

Embodiments of the herein-disclosed architecture can be implemented using computer-readable program code stored by a computer-readable medium. The computer-readable program code causes a computer system having one or more processors to provide the various blocks depicted in FIG. 1 and to perform the acts associated therewith. Examples of the computer-readable medium include, but are not limited to, a magnetic medium such as a hard disk or a floppy disk, an optical medium such as an optical disk (e.g. a CD or a DVD), and an electronic medium such as an electronic memory (e.g. a removable memory card or an integrated memory in the computer system).

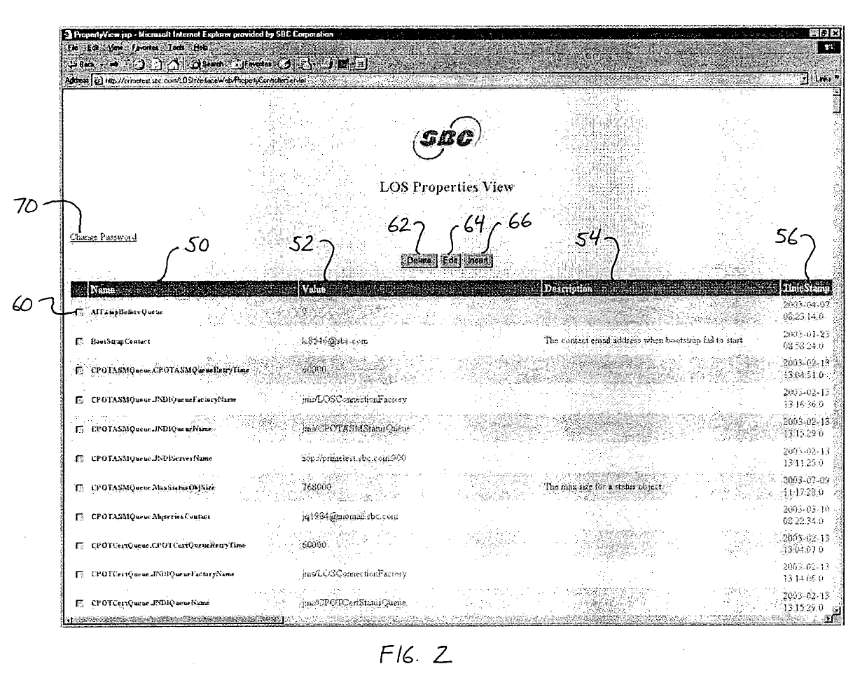

FIG. 2 is a screen shot in an embodiment of the property management Web interface 12. The Web interface displays each property and its associated information in a corresponding row. Displayed in each row is a property name, a property value, an optional description associated with the property, and a date and time stamp associated with the property. For all of the displayed properties, the property names are displayed in a column 50, the property values are displayed in a column 52, the descriptions are displayed in a column 54, and the date and time stamps are displayed in a column 56.

Each property is user-selectable by an associated check box (a representative one being indicated by reference numeral 60). A delete button 62, when selected by a user, initiates deletion of one or more user-selected properties. An edit button 64, when selected by the user, initiates editing of one or more user-selected properties. An insert button 66, when selected by the user, initiates a process to facilitate a new property to be inserted.

The user can change his/her password to access the Web interface by selecting a hyperlink 70.

It will be apparent to those skilled in the art that the disclosed embodiments may be modified in numerous ways and may assume many embodiments other than the preferred forms specifically set out and described herein. For example, embodiments of the present invention may be used for property management in non-Web applications. Further, the Web interface layer 12 may be replaced by another user interface layer, such as a GUI, having substantially the same features.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

1. A system comprising:
a persistence layer to store a plurality of properties in a computer-readable storage medium;
a property manager layer to retrieve from the persistence layer values of those of the properties used by a first software application and to provide the values to the first software application at run time;
a first property listener to modify values of program variables in the first software application that are dependent on the properties without having to restart the first software application;
a user interface layer to accept user input to update at least one of the properties, wherein the persistence layer is responsive to the user interface layer to update the at least one of the properties in the computer-readable storage medium based on the user input, and wherein the user interface layer is to notify the property manager layer that the at least one of the properties has been updated;
wherein the property manager layer is to determine if any of the at least one of the properties that has been updated is used by the first software application, and to notify the first property listener of at least one updated property value used by the first software application based thereon; and
wherein the first property listener is to modify at least one program variable in the first software application that is dependent on the at least one updated property value without restarting the first software application.

2. The system of claim 1 further comprising:
a second property listener to modify values of program variables in the second software application that are dependent on the properties without having to restart the second software application;
wherein the property manager layer is to determine if any of the at least one of the properties that has been updated is used by the second software application, and to notify the second property listener of at least one updated property value used by the second software application based thereon; and
wherein the second property listener is to modify at least one program variable in the second software application that is dependent on the at least one updated property value without restarting the second software application.

3. The system of claim 2 wherein each of the properties is identified by an associated property key, and wherein the property manager layer comprises a lookup table to record, for each of the property keys, a list of property listeners that have registered for the property key.

4. The system of claim 2 wherein the first software application comprises a first application class of a middleware application, and wherein the second software application comprises a second application class of the middleware application.

5. The system of claim 4 wherein the middleware application provides flow through from a plurality of ordering applications to at least one back-end application.

6. The system of claim 4 wherein the property manager layer is contained within a common project within the middleware application.

7. The system of claim 4 wherein the property manager layer is contained in a client JAVA Archive (JAR) file.

8. The system of claim 4 wherein the property manager layer is contained in a Dynamic Link Library (DLL) file.

9. The system of claim 1 wherein the persistence layer is to store information associated with the properties.

10. The system of claim 9 wherein, for each of at least one of the properties, the information comprises a version number, a time stamp, an author name, and a description associated therewith.

11. The system of claim 9 wherein the user interface layer is to display a name, a value, and the information associated with at least one of the properties.

12. The system of claim 11 wherein the user interface layer is to accept user input to update the value associated with a property.

13. The system of claim 11 wherein the user interface layer is to accept user input to update the information associated with a property.

14. The system of claim 11 wherein the user interface layer further is to display a time stamp associated with the at least one of the properties.

15. The system of claim 1 wherein the user interface layer accepts user input to add a property, to modify a property, and to delete a property.

16. The system of claim 1 wherein the user interface layer is to organize and display the properties in a plurality of categories.

17. The system of claim 1 wherein the user interface layer comprises a Web interface layer.

18. The system of claim 1 wherein the user interface layer is to display the properties in a searchable format.

19. A method comprising:
storing a plurality of properties in a computer-readable storage medium;
retrieving, from the computer-readable storage medium, values of those of the properties used by a first software application and to provide the values to the first software application at run time;
accepting user input to update at least one of the properties;
updating the at least one of the properties in the computer-readable storage medium based on the user input;
based on the user input, determining if any of the at least one of the properties that has been updated is used by the first software application;
notifying a first property listener of at least one updated property value used by the first software application; and
modifying, by the first property listener, at least one program variable in the first software application that is dependent on the at least one updated property value without restarting the first software application.

20. A computer-readable medium having computer-readable program code to cause a computer system to perform acts of:
storing a plurality of properties in a computer-readable storage medium;
retrieving, from the computer-readable storage medium, values of those of the properties used by a first software application and to provide the values to the first software application at run time;
accepting user input to update at least one of the properties;
updating the at least one of the properties in the computer-readable storage medium based on the user input;
based on the user input, determining if any of the at least one of the properties that has been updated is used by the first software application;
notifying a first property listener of at least one updated property value used by the first software application; and
modifying, by the first property listener, at least one program variable in the first software application that is dependent on the at least one updated property value without restarting the first software application.
